(19) United States
(12) Patent Application Publication
(10) Pub. No.: US 2009/0224547 A1
(43) Pub. Date: Sep. 10, 2009

(54) APPARATUS FOR HARNESSING WAVE ENERGY

(76) Inventor: Rakesh Garg, Richardson, TX (US)

Correspondence Address: RAKESH GARG, 4521 COPPER MOUNTAIN LN, RICHARDSON, TX, 75082, US

(21) Appl. No.: 12/045,021

(22) Filed: Mar. 9, 2008

(51) Int. Cl. F03B 13/14

(52) U.S. Cl. 290/53

(57) ABSTRACT

A system and apparatus for harnessing wave energy are provided in the illustrative embodiments. A housing is configured to have a set of openings. The set of openings are configured to allow each of a first flow of a fluid and a second flow of the fluid to enter and exit the housing. Several projections are configured to receive a first force from the first flow of the fluid and receive a second force from the second flow of the fluid. A belt is configured to couple to the projections and move from the projections receiving the force. A set of spindles is configured to couple to the belt. Each spindle in a subset of the set of spindles is further configured to receive a torque from the movement of the belt. A shaft is configured to receive the torque from each spindle in the subset in a cumulative manner.

### BACKGROUND OF THE INVENTION

1. Field of the Invention

The present invention relates generally to an improved energy generating system, and in particular, to an apparatus for generating clean and renewable energy. Still more particularly, the present invention relates to a system and apparatus for harnessing wave energy.

2. Description of the Related Art

Majority of electrical energy and mechanical energy consumed today is generated using fossil fuels.

Fossil fuels include coal, petroleum, natural gas, and their various distillates. Fossil fuels are non-renewable source of energy because there exists only a finite quantity of such fuels in natural deposits in Earth's strata. Once those deposits are depleted, the fossil fuels cannot be replenished.

Fossil fuels are also known to produce byproducts during combustion in the process of generating energy. Some of these byproducts contaminate the land, air, and water in ways that have long term harmful effects for the planet and the population. For example, Carbon dioxide, a common byproduct of fossil fuel combustion, contaminates the air and causes a greenhouse effect that contributes to global warming. Many other hydrocarbons and Nitrogen compounds are byproducts of combusting fossil fuels and remain in the atmosphere causing haze, poor air quality, poor water quality, and acid rains.

Renewable fuels or renewable sources are energy sources that may not be depleted, or easily replenished upon consumption. For example, solar energy and wind energy can be harnessed perpetually without depleting the source of those energies. Renewable energy is energy generated from renewable fuels.

Clean energy is energy whose generation or consumption does not contribute contaminants to land, air, or water. For example, electricity may be clean energy to the extent that its consumption does not contribute any contaminants. However, electricity may not always be clean energy because some methods of generating electricity consume fossil fuels, which contributes contaminants. As another example, electricity generated from solar energy may be clean energy because neither the generating nor the consumption of such electricity contributes contaminants to land, air, or water.

Generating clean energy from renewable sources has certain drawbacks. For example, to generate sufficient amounts of electricity, such as to operate an average size house, large solar panels of photovoltaic cells have to be exposed to sunlight. The surface area of such panels can often exceed the entire roof area of an average size house. Solar panels installed on the roof and in the yards disturb the aesthetics of the house, may be clumsy to clean and maintain, not to mention prohibitively expensive and cost-ineffective for dwellers of average size houses.

As another example, wind-mills require towers upon which the blades of the wind turbine can be mounted to catch the free flow of wind streams. Such towers have to be tall, taller than most houses. Furthermore, numerous towers have to be erected to mount several wind turbines to generate sufficient amount of electricity. The wind-mills also occupy large land areas and make for visually unpleasant skylines. Thus, wind-mills also require large capital investment for the equipment, may be difficult to maintain, noisy, and may be aesthetically disturbing to the population.

### SUMMARY OF THE INVENTION

The illustrative embodiments provide a system and apparatus for harnessing wave energy. A housing is configured to have a set of openings. The set of openings are configured to allow each of a first flow of a fluid and a second flow of the fluid to enter and exit the housing. Several projections are configured to receive a first force from the first flow of the fluid and receive a second force from the second flow of the fluid. A belt is configured to couple to the projections. The belt is configured to move from the projections receiving the force. A set of spindles is configured to couple to the belt. Each spindle in a subset of the set of spindles is further configured to receive a torque from the movement of the belt. A shaft is configured to receive the torque from each spindle in the subset in a cumulative manner.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of illustrative embodiments when read in conjunction with the accompanying drawings, wherein:

FIG. 1 depicts a sketch of a typical wave motion at a beach in accordance with an illustrative embodiment;

FIG. 2 depicts a cross-sectional view of wave energy drive in accordance with an illustrative embodiment;

FIG. 3A depicts one exemplary configuration of projections on a belt in accordance with an illustrative embodiment;

FIG. 3B depicts a second exemplary configuration of projections on a belt in accordance with an illustrative embodiment;

FIG. 4A depicts a view of configuration of a housing in accordance with an illustrative embodiment;

FIG. 4B depicts a different view of a configuration of a housing in accordance with an illustrative embodiment;

FIG. 5 depicts a configuration of a drive shaft coupled with a wave energy drive in accordance with an illustrative embodiment; and

FIG. 6 depicts a generator that may be coupled with a wave energy drive in accordance with an illustrative embodiment.

### DETAILED DESCRIPTION OF THE PREFERRED EMBODIMENT

Waves, such as those in large bodies of water, such as lakes, seas, and oceans, have long been contemplated as renewable source of clean energy. Energy that can be harnessed from the motion of waves is called wave energy.

However, illustrative embodiments recognize that harnessing wave energy may be difficult and expensive by the present technology. Harnessing wave energy is converting wave energy into a transportable form of energy, such as electricity, or force, such as a reciprocating or a rotary force. A generator may be an electrical device that generates electricity from a mechanical motion, such as the rotation of a turbine shaft. A wave energy generator is a generator that converts wave energy to electricity. A wave energy drive is a mechanism to convert the motion of the waves into a motion that can be used in a generator, such as to generate electricity, or in a motor or engine, such as to operate a mill. The motion produced by the wave energy drive of the illustrative embodiments may be, for example, reciprocating, rotary, or of other characteristic.

Furthermore, the illustrative embodiments recognize that the generators based on present technology have to be deployed at a substantial distance from the shores, making them difficult to access, maintain, repair, or operate. The illustrative embodiments further recognize that transporting the electricity generated by presently developed wave energy generators may be difficult at least because of the substantial distance of the generators from the shore.

Illustrative embodiments provide a system and apparatus for harnessing wave energy that may overcome these and other problems associated with using waves as a renewable source of energy. By using the system and apparatus described in the illustrative embodiments, wave energy can be harnessed, such as for generating electricity, in a more convenient way as compared to the presently available wave energy generators. The system and apparatus of the illustrative embodiments may overcome the above described problems as well as other problems associated with the presently available wave energy generators. A particular embodiment may have all, some, or none of the advantages described herein.

Furthermore, the illustrative embodiments are described using an ocean, a beach, and water circumstances only for the clarity of the description. An implementation may use the illustrative embodiments in other bodies of water, other fluids, and other suitable locations without departing from the scope of the illustrative embodiments.

With reference to FIG. 1, this figure depicts a sketch of a typical wave motion at a beach in accordance with an illustrative embodiment. Wave 102 approaches beach 104 from deeper waters. Oncoming wave current 106 may be thus directed towards beach 104 on the upper part of wave 102. A current is a motion of a mass of water having a certain direction. An oncoming wave current is a current caused by a wave coming from the body of the water to a shore or a beach.

Simultaneously, the water brought to beach 104 by a previous wave, similar to wave 102 but preceding wave 102 in time, returns below the oncoming wave current 106, forming return current 108. A return current is the current created by a mass of water returning from a shore or beach of a body of water to the body of water. Other currents may proceed in other directions, such as, for example, when a current may be wholly within the body of water, or when a return current causes a current to proceed in a direction other than the direction of the open waters.

Wave motion created by oncoming wave current 106 and returning current 108 may create a churning motion, churn 110, at shallow bed 112. Shallow bed 112 may be the surface below a volume of water that may be proximate to beach 104 where churn 110 may be pronounced and perceptible. For example, typically, an ocean beach leads into the ocean such that a person can walk some distance into the ocean with his feet touching the bed of the ocean. From the beach to some distance into the ocean depending on the particular location, an average sized adult may experience the wave pushing his upper torso towards the beach and the water pulling his feet towards the open waters of the ocean. The floor of the ocean for such a distance into the ocean may be one example of shallow bed 112.

A device, such as a board or a log, that may be taller than the average sized adult in the previous example, may be subjected to churn 110 for a greater distance from beach 104. Consequently, shallow bed 112 may stretch farther from beach 104 depending on the nature of the device experiencing churn 110, and the particular location of implementing the illustrative embodiments.

Note that wave motion in water bodies may not be distinguishable from one wave to another. However, the general motion of the waves follows the described process of oncoming wave current 106 and return current 10 causing churn 110 for some distance from beach 104.

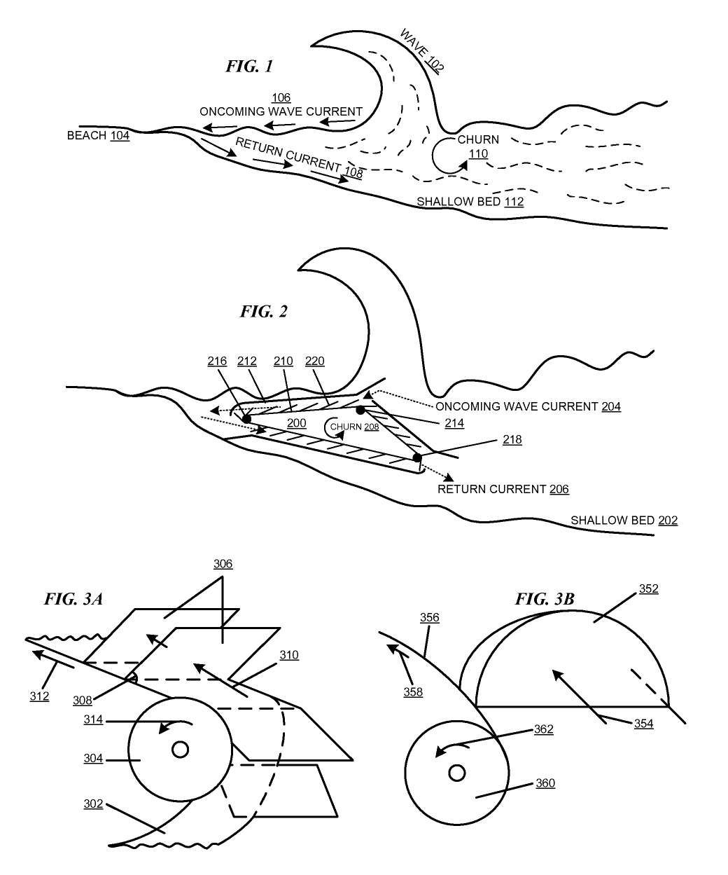

With reference to FIG. 2, this figure depicts a cross-sectional view of wave energy drive in accordance with an illustrative embodiment. Wave energy drive 200 is depicted as situated on shallow bed 202. Shallow bed 202 may be similar to shallow bed 112 in FIG. 1. The situation of wave energy drive 200 allows oncoming wave current 204 and return current 206 to enter and exit wave energy drive 200 as shown. Oncoming wave current 204 may be similar to oncoming wave current 106 in FIG. 1. Return current 206 may be similar to return current 108 in FIG. 1. Oncoming wave current 204 and return current 206 may cause churn 208, which may be similar to churn 110 in FIG. 1.

Wave energy drive 200 includes housing 210, belt 212, and spindles 214, 216, and 218. Housing 210 houses an assembly that includes belt 212 and spindles 214, 216, and 218, among other components of wave energy drive 200 (not shown). Housing 210 may be of any design suitable for allowing oncoming wave current 204 to enter housing 210 and pass over belt 212, applying force to projections 220 on belt 212.

Projections 220 may be of any shape or form, and may be coupled to belt 212 in any manner such that a force applied to projections 220 moves belt 212 in the general direction of the force at the point where projections 220 couple to belt 212. A force applied to projections 220 in this manner may apply a torque to a spindle coupled to the belt. A spindle may be coupled to the belt in any suitable way, such as by friction or chain and sprocket.

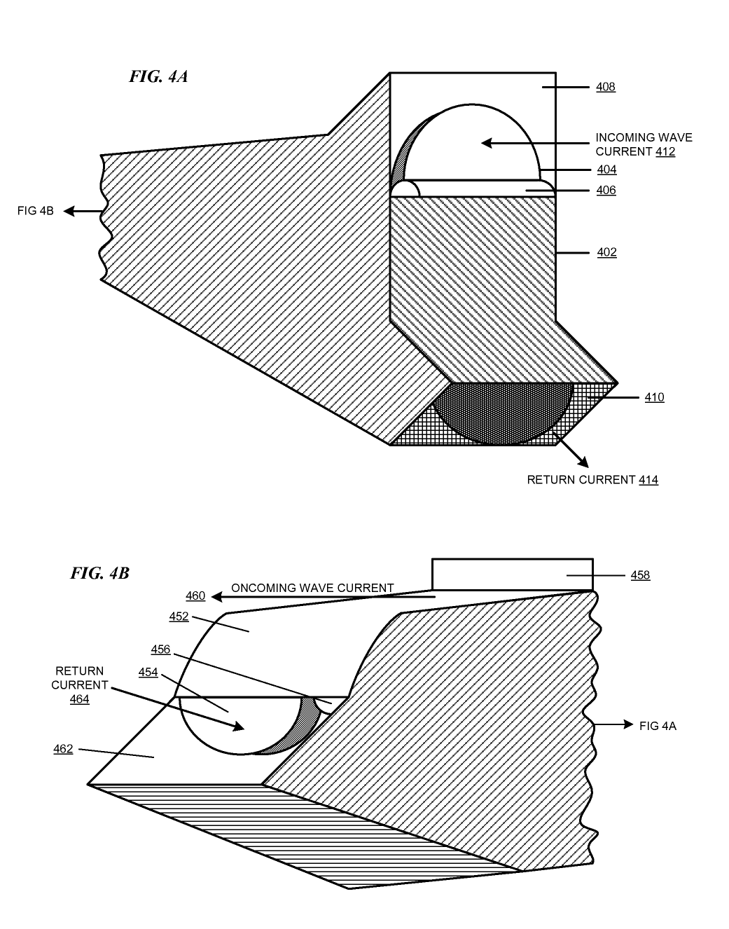

Projections 220 may be generally of a shape that allows the fluid of oncoming wave current 204 to transfer a majority of the force of oncoming wave current 204 to projections 220. Two exemplary configurations of projections 220 are depicted in FIGS. 3A and 3B.

Belt 212 may move on one or more spindles. Spindles 214, 216, and 218 are three exemplary spindles on which belt 212 may move in a loop. In one embodiment, belt 212 may form a loop over two spindles, such as in an implementation where housing 210 has to be substantially flat. In another embodiment, as depicted in FIG. 2, belt 212 forms a loop over three spindles so that the loop forms a generally triangular shape. The sizes of the sides of the triangle formed by the loop may be adjusted, as may be the internal angles between them, to achieve a desired profile of the loop.

Specific profiles of the loop formed by belt 212 may be created to suit a specific shape of shallow bed 202. For example, in another embodiment, belt 212 may form a generally quadrilateral loop over four spindles, such as by positioning another spindle between spindles 216 and 218 in this figure. When placed inside the loop in this manner, such a spindle may cause belt 212 to form a loop that may be suitable for a shallow bed that has a larger gradient towards the beach as compared to the gradient towards the open water. Many other configurations of belt 212 and one or more spindles will be conceivable from this disclosure.

A waterwheel may be a commonly known method of harnessing the potential energy of water falling from a height onto the blades of the waterwheel. However, a waterwheel harnesses only the force of falling water on one side of the waterwheel. Turbine equivalents of a waterwheel similarly harness the energy of the fluid flowing in one direction only. Wave energy drive 200, in contrast, harnesses the energy of the waves in both directions—when oncoming to the beach and when receding from the beach.

Operating in this manner, wave energy drive 200 harnesses the energy from a fluid in multiple directions depending on the changing direction of the flow of the fluid at any given time. Moreover, waterwheels and turbines have to be oriented into the singular direction of the fluid flow. Once oriented in this manner, any other direction in which the fluid may be flowing may not be harnessed by the same turbine. In contrast, the belt loop in wave energy drive 200 may be configured so that wave energy drive 200 can harness the energy from a fluid that may be flowing in multiple directions. Wave energy drive 200 may be coupled to a generator, such as for generating electricity. The resulting combination may be a wave energy generator according to the illustrative embodiments. Wave energy drive 200 may also be coupled to a motor or engine for providing mechanical force. The resulting combination may be a wave energy motor or a wave energy engine according to the illustrative embodiments.

With reference to FIG. 3A, this figure depicts one exemplary configuration of projections on a belt in accordance with an illustrative embodiment. Belt 302 may be similar to belt 212 in FIG. 2. Projections 306 may be analogous to projections 220 in FIG. 2.

Here, projections 306 are shown coupled to belt 302 at angle 308 such that a majority of force 310 transfers to projections 206. In one embodiment, spindle 304 may be similar to spindle 214 in FIG. 2. In such an embodiment, depicted force 310 may be the force of an oncoming wave current, such as oncoming wave current 204 in FIG. 4. In another embodiment, spindle 304 may be similar to spindle 216 in FIG. 2. In such an embodiment, depicted force 310 may be the force of a returning current, such as returning current 206 in FIG. 2.

Force 310 applied to projections 306 causes belt 302 to move in direction 312. Motion of belt 302 in direction 312 causes spindle 304 to turn in direction 314.

In this exemplary configuration, projections 306 are depicted as generally flat surfaces coupled at an acute angle, angle 308, to belt 302. In particular implementations, however, angle 308 may be any suitable angle. For example, in one embodiment angle 308 may be a right angle. Projections 306 may be of any shape—such as substantially flat or curved surface of any geometrical shape or other shape.

With reference to FIG. 3B, this figure depicts a second exemplary configuration of projections on a belt in accordance with an illustrative embodiment. Projection 352 may be analogous to one projection in projections 306 in FIG. 3.

In this exemplary embodiment, projection 352 may be a concave surface such that force 354 applies to the concave side of projection 352. Force 354 applied to projection 352 in this manner may cause belt 356 to move in direction 358. Motion of belt 356 in direction 358 may cause a torque to be applied to spindle 360, turning spindle 360 in direction 362.

The particular shapes of the projections, angles of the projections with respect to the belt, and coupling of the projections with the belt depicted in FIGS. 3A and 3B are only as exemplary. Many other shapes, angles, and couplings will become apparent from this disclosure and are contemplated within the scope of the illustrative embodiments. Furthermore, the belt's coupling to the one or more spindles is also depicted only as exemplary. A belt may be coupled to a spindle in alternative ways, such as by using chain for a belt coupled to a sprocket on a spindle, or meshing compatible gears on the belt and the spindle, without departing from the scope of the illustrative embodiments.

With reference to FIG. 4A, this figure depicts a view of configuration of a housing in accordance with an illustrative embodiment. Housing 402 may be analogous to housing 210 in FIG. 2. Projections 404 may be analogous to one or more projection 352 in FIG. 3B. Projections 404 may be coupled to belt 406, which may be analogous to belt 356 in FIG. 3B.

Housing 402 may have several openings for the entry and exit of various currents. For example, the portion of exemplary housing 402 visible in FIG. 4A is shown to have openings 408 and 410. In the exemplary configuration of FIG. 4A, opening 408 allows the water of oncoming wave current 412 to enter housing 402 and apply force to projections 404. Opening 410 allows the water of return current 414 to exit housing 402. Exit opening for oncoming wave current 412 and entry opening for return current 414 are not shown in FIG. 4A but are depicted in FIG. 4B.

With reference to FIG. 4B, this figure depicts a different view of a configuration of a housing in accordance with an illustrative embodiment. Housing 452 is the same as housing 402 in FIG. 4A. Projections 454 may be analogous to one or more projections 404 in FIG. 4A. Projections 454 are coupled to belt 456, which is the same as belt 406 in FIG. 4A.

Opening 458 may be an exit opening in housing 452 for oncoming wave current 460. Oncoming wave current 460 may be the same as or similar to oncoming wave current 412 in FIG. 4A. Opening 462 may be an entry opening in housing 452 for return current 464. Return current 464 may be the same as or similar to return current 414 in FIG. 4A.

One entry opening and one exit opening for the oncoming wave current and the return current are depicted in FIGS. 4A and 4B only as exemplary. In a particular configuration, multiple openings in housing 402 may allow entry and exit of the oncoming wave current and return current in multiple locations in housing 402.

Furthermore, the various entry and exit openings may be situated anywhere and oriented in any direction on the housing to facilitate the entry and exit of the various currents in particular implementations. For example, in one embodiment, two openings for return current entry may be situated on the bottom surface of the housing. One of the two openings may be oriented similar to opening 462 in FIG. 4B, and the other opening may be situated approximately in the middle of the bottom surface. The first opening may be oriented to face upwards so as to catch a downward directed return current. The second opening may be oriented substantially horizontally, to catch a substantially horizontal return current in the proximity of the second opening. Many other locations and orientations of the various openings are conceivable from this disclosure and the same are contemplated within the scope of the illustrative embodiments. Furthermore, the housing may be configured such that the openings may be re-oriented to suit the directions of the various currents in a given location where the wave energy drive may have to be deployed.

With reference to FIG. 5, this figure depicts a configuration of a drive shaft coupled with a wave energy drive in accordance with an illustrative embodiment. Belt 502 may be similar to belt 406 in FIG. 4A, projections 504 may be similar to projections 404 in FIG. 4A.

Any of spindles 506, 508, 509, and 510 may be similar to any of spindles 214, 216, and 218 in FIG. 2. Gears, pulleys, belts, or other coupling mechanisms may be coupled with spindles 506, 508, 509, and 510 to enable a transfer the torque from the respective spindles to other components, such as drive shaft 512.

Drive shaft 512 may be coupled to a suitable coupling mechanism to receive the torque from one or more spindles. This figure depicts an exemplary system of gears coupled with spindles 506, 509, and 510. These gears exemplarily couple with a compatible system of gears on drive shaft 512. Spindle 508 is depicted to be optionally coupled via a system of gears or belts to drive shaft 512. The coupling mechanism between spindles 506, 508, 510, and drive shaft 512 may be such that drive shaft 512 receives torque in a cumulative manner from those spindles to turn drive shaft 512. Torque is received in a cumulative manner when torque from one source substantially adds to a torque from another source at the point where the torque is received. For example, in the example depicted in this figure, spindles 506, 508, and 510 couple with drive shaft 512 such that the torque from each spindle is substantially added to the torque from the other spindles, and the combined torque from those spindles turns drive shaft 512 in a common direction.

Note that in an implementation of the illustrative embodiment, any spindle may be associated with a system of one or more gears, belts, pulleys, other methods of coupling shafts and spindles, or a combination thereof to couple to a drive shaft. Furthermore, a spindle may or may not couple to the drive shaft in a particular configuration.

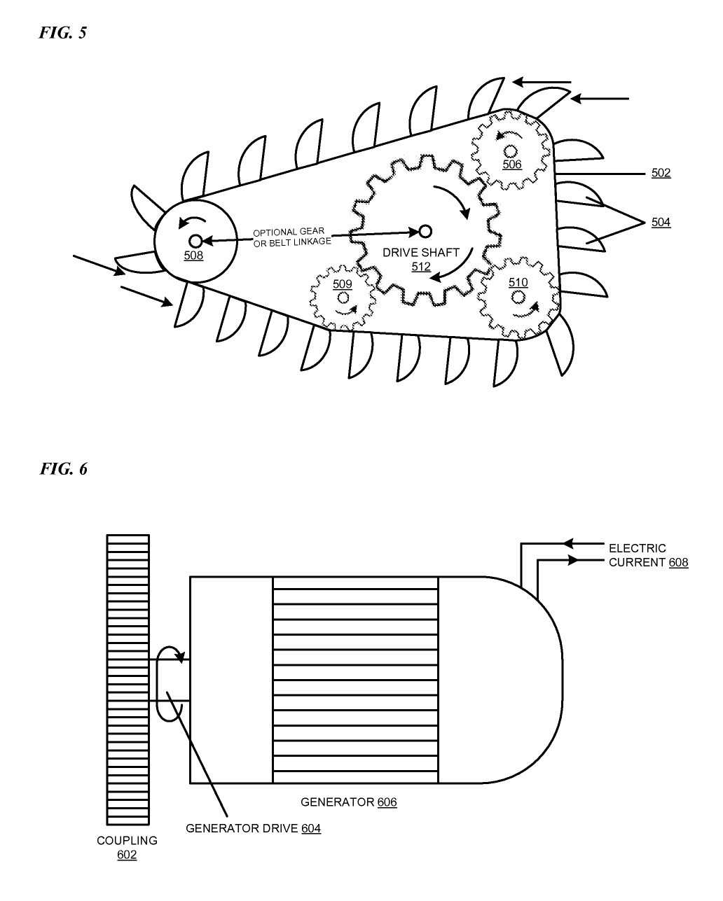

With reference to FIG. 6, this figure depicts a generator that may be coupled with a wave energy drive in accordance with an illustrative embodiment. Generator drive 604 may be analogous to drive shaft 512 in FIG. 5. Alternatively, generator drive 604 may be coupled to drive shaft 512 in FIG. 5 using a system of linkages or couplings suitable for transferring power. Some examples of the linkages and couplings may be a flange, a gearbox, a hydraulic coupling, a universal joint, a piston, belt and pulleys, chain and sprocket, friction coupling, electronic or electrical coupling, and magnetic coupling.

Coupling 602 may be an exemplary coupling that may be coupled to generator drive 604. Coupling 602 may be used to couple generator drive 604 with a drive shaft in a wave energy drive according to the illustrative embodiments. In this example, coupling 602 may be coupled to one or more spindles in a wave energy drive as described with respect to FIG. 5. Turning coupling 602 in the manner described with respect to FIG. 5 turns generator drive 604 of generator 606. Generator 606 converts the turning motion of generator drive 604 to electricity, generating electric current 608. Other types of couplings may couple a generator to the wave energy drive of the illustrative embodiments.

Thus, the illustrative embodiments provide a system and apparatus for harnessing wave energy. The wave energy drive of the illustrative embodiments may be used to harness the energy from any fluid that is flowing in multiple directions. For example, when deployed to harness the energy from waves in bodies of water, the wave energy drive of the illustrative embodiments can harness the energy from the oncoming waves currents as well as the return currents and any other currents.

Furthermore, the wave energy drive of the illustrative embodiments can harness the energy from additional directions of the oncoming or returning waves. For example, the wave energy drive can be adopted to include openings for oncoming wave currents where the oncoming waves come from different directions to guide those oncoming wave currents to the projections. As another example, the wave energy drive can be adopted to include openings for return currents where the returning wave changes directions, such as from the changing topography of the shallow bed. Similarly, the wave energy drive of the illustrative embodiments can be adopted to include any number of openings to accommodate any number of currents from any direction.

The illustrative embodiments may be implemented such that the resulting wave energy drive may be submerged underwater at a beach or at some distance from a beach. Such implementations may prevent unsightly obstructions in the aesthetics of ocean beaches. Alternatively the housing of the wave energy drive of the illustrative embodiments can be formed so as to blend into the surroundings at a particular locale. For example, the housing may be exposed, but may be formed to resemble large boulders to blend into the natural surroundings of a given location.

Being proximate to the beach, conducting the electric current from a wave energy generator of the illustrative embodiments to a power distribution facility may be easier than conducting electricity from other wave energy generators deployed farther into the deep waters. For example the cables running from the wave energy generator of the illustrative embodiments to the power distribution facility can be buried under the sands and silt at the beach and the shallow bed. Additionally, being proximate to the beach, the wave energy drives of the illustrative embodiments may be easier to maintain and repair as compared to other wave energy drive deployed farther into the deep waters.

The belts and gears are described only as exemplary. Any mechanism for transferring force from the projections to the spindles, and transferring the torque from the spindles to the generator may be used without departing from the scope of the illustrative embodiments. For example, the projections may be mounted on a chain that couples to corresponding sprockets on a spindle. A spindle may be coupled to a generator shaft using gears, a gearbox, a system of pulleys and belts, a solid linkage, chain and sprocket, or a friction drive, a flange, a hydraulic coupling, a universal joint, a piston, electronic or electrical coupling, and magnetic coupling.

Additionally, the spindles, the loop of the belt, and the projections need not be in the same vertical plane inside the housing. For example, the spindles may be so arranged in a housing that the projections receiving the oncoming wave current and the projections receiving the return current may lie in different vertical planes.

Furthermore, the material of the various components of the wave energy drive may be selected according to the characteristics of the environment where the wave energy drive may be contemplated to be deployed. For example, when the wave energy drive of the illustrative embodiments is deployed to harness ocean wave energy, the materials may be chosen to be resistant to corrosion or deterioration from salt. As another example, when the wave energy drive may be expected to be deployed in a fluid flow where the force exerted by the flowing fluid may be above a threshold, the materials may be reinforced suitably according to the force of the fluid flow.

Furthermore, any kind of generator may be coupled with the wave energy drive of the illustrative embodiment. For example, the torque of the spindles may be converted to reciprocating motion through known mechanisms to drive a piston engine to generate reciprocating mechanical force. As another example, instead of a generator, an implementation may couple another device to the generator shaft and use the mechanical power directly instead of converting the mechanical power from the mechanical torque into electricity or another form of energy. Using the turning of the shaft for turning a mill may be one such example.

The description of the present invention has been presented for purposes of illustration and description, and may be not intended to be exhaustive or limited to the invention in the form disclosed. Many modifications and variations will be apparent to those of ordinary skill in the art. The illustrative embodiments were chosen and described in order to best explain the principles of the invention, the practical application, and to enable others of ordinary skill in the art to understand the invention for various embodiments with various modifications as are suited to the particular use contemplated.

What may be claimed is:

1. A system for harnessing wave energy, the system comprising:
a housing configured to have a set of openings, the set of openings being configured to allow each of a first flow of a fluid and a second flow of the fluid to enter and exit the housing;
a plurality of projections configured to receive a first force from the first flow of the fluid and receive a second force from the second flow of the fluid;
a belt configured to couple to the plurality of projections, the belt being configured to move from the plurality of projections receiving the force;
a set of spindles configured to couple to the belt, each spindle in a subset of the set of spindles further configured to receive a torque from the movement of the belt; and
a generator configured to receive the torque from each spindle in the subset in a cumulative manner.

2. The system of claim 1, wherein the set of openings further comprises:
a first subset of the set of the openings configured to allow the first flow of the fluid to enter the housing;
a second subset of the set of the openings configured to allow the first flow of the fluid to exit the housing;
a third subset of the set of the openings configured to allow the second flow of the fluid to enter the housing; and
a fourth subset of the set of the openings configured to allow the second flow of the fluid to exit the housing.

3. The system of claim 1, wherein the belt is one of a chain and a lever.

4. The system of claim 1, wherein the generator is configured to receive the torque from a shaft, and wherein the shaft is configured to receive the torque from the spindles in the subset of spindles.

5. The system of claim 1, wherein the spindles in the set of spindles are arranged such that the belt positions the plurality of projections according to a first direction of the first force and a second direction of the second force.

6. The system of claim 1, wherein a first direction of the first force and a second direction of the second force are one of substantially opposite of each other and substantially perpendicular to each other.

7. The system of claim 1, wherein a spindle in the set of spindle and the belt are coupled by friction.

8. The system of claim 1, wherein a spindle in the set of spindles and the generator are coupled using one of a system of gears, a system of belts and pulleys, and a solid linkage.

9. A wave energy drive, comprising:
a housing configured to have a set of openings, the set of openings being configured to allow each of a first flow of a fluid and a second flow of the fluid to enter and exit the housing;
a plurality of projections configured to receive a first force from the first flow of the fluid and receive a second force from the second flow of the fluid;
a belt configured to couple to the plurality of projections, the belt being configured to move from the plurality of projections receiving the force;
a set of spindles configured to couple to the belt, each spindle in a subset of the set of spindles further configured to receive a torque from the movement of the belt; and
a shaft configured to receive the torque from each spindle in the subset in a cumulative manner.

10. The wave energy drive of claim 9, wherein the set of openings further comprises:
a first subset of the set of the openings configured to allow the first flow of the fluid to enter the housing;
a second subset of the set of the openings configured to allow the first flow of the fluid to exit the housing;
a third subset of the set of the openings configured to allow the second flow of the fluid to enter the housing; and
a fourth subset of the set of the openings configured to allow the second flow of the fluid to exit the housing.

11. The wave energy drive of claim 9, wherein the belt is one of a chain and a lever.

12. The wave energy drive of claim 9, wherein the spindles in the set of spindles are arranged such that the belt positions the projections according to a first direction of the first and a second direction of the second force.

13. The wave energy drive of claim 9, wherein a first direction of the first force and a second direction of the second force are one of substantially opposite of each other and substantially perpendicular to each other.

14. The wave energy drive of claim 9, wherein a spindle in the set of spindle and the belt are coupled by friction.

15. The wave energy drive of claim 9, wherein a spindle in the set of spindles and the shaft are coupled using one of a system of gears, a system of belts and pulleys, and a linkage.

16. A method for harnessing wave energy, the method comprising:
allowing through a set of openings in a housing a first flow of a fluid to enter and exit the housing and a second flow of the fluid to enter and exit the housing;
receiving at a plurality of projections a first force from the first flow of the fluid;
receiving at the plurality of projections a second force from the second flow of the fluid;
applying the first force and the second force in a cumulative manner to a shaft.

17. The method of claim 16, wherein the set of openings further comprises:
a first subset of the set of the openings configured to allow the first flow of the fluid to enter the housing;
a second subset of the set of the openings configured to allow the first flow of the fluid to exit the housing;
a third subset of the set of the openings configured to allow the second flow of the fluid to enter the housing; and
a fourth subset of the set of the openings configured to allow the second flow of the fluid to exit the housing.

18. The method of claim 16, further comprising:
positioning the plurality of projections according to a first direction of the first and a second direction of the second force.

19. The method of claim 16, wherein a first direction of the first force and a second direction of the second force are one of substantially opposite of each other and substantially perpendicular to each other.
